(19) United States
(12) Patent Application Publication
(10) Pub. No.: US 2016/0173421 A1
(43) Pub. Date: Jun. 16, 2016

(54) COMMUNICATION VERIFICATION BASED UPON MESSAGE CONTENT AND RECIPIENT PROFILE

(71) Applicant: LENOVO ENTERPRISE SOLUTIONS (SINGAPORE) PTE. LTD. CORPORATION, New Tech Park (SG)

(72) Inventors: Shareef Alshinnawi, Apex, NC (US); Gary D. Cudak, Wake Forest, NC (US); Christopher J. Hardee, Raleigh, NC (US); Vinod Kamath, Raleigh, NC (US); Jason A. Matteson, Raleigh, NC (US)

(21) Appl. No.: 14/568,211

(22) Filed: Dec. 12, 2014

(51) Int. Cl. H04L 12/58

(52) U.S. Cl. CPC H04L 51/046; H04L 51/16

(57) ABSTRACT

Embodiments of the invention provide a method, system and computer program product for verification of message content in a real time messaging system. The method includes contextually analyzing a thread of messages in a user interface of the real time messaging system, the thread defining a conversation between a composer and one or more recipients of the messages, the analysis determining a context of the conversation. The method further includes loading a new message to be transmitted as part of the thread, parsing text of the new message and analyzing the parsed text to determine a context. The method yet further includes comparing the determined context of the new message to the determined context of the conversation. Finally, the method includes displaying in the user interface a warning to the composer when the context of the new message differs from the context of the conversation.

### BACKGROUND OF THE INVENTION

1. Field of the Invention

The present invention relates to real time messaging and more particularly to message management in a real time messaging system.

2. Description of the Related Art

Real time messaging pertains to the exchange of electronic messages between two or more computing devices in real time. Real time messaging generally refers to peer-to-peer messaging, not broadcast or multicast messaging, though it is widely understood that real time messaging may occur between multiple endpoint in a “conference” setting. In real time messaging, there always remains a direct path between the source and the destination of a message, although the communications link might include several intermediate nodes between source and sink of a message. To wit, in real time messaging, a message travels from source to destination without requiring more than transient storage in any location. Real-time communications generally are understood to include instant messaging and text messaging and other Internet based “chat” vehicle. Real time messaging is to be compared to time shifted communications such as electronic mail in which an electronic message traverses an indirect communications path from source to destination, including several points of intermediate storage in different mail servers.

In the course of indirect communications, one composes a message and directs a mail server to transmit the message to one or more designated recipients. However, the message is seldom transmitted immediately. In fact, in many cases, the message can be retracted at any time prior to the designated recipient opening the message. In some cases, the message can be retracted even before the message ever leaves the client in which the message had been composed. So much is not true with respect to real time messaging. In real time messaging, once a message has been directed for transmission to a recipient, the message cannot be retrieved. Indeed, to the extent the message is delivered in real time, the message typically is delivered to the recipient even before a sender of the message realizes a desire to retract the message.

There are many reasons why a sender of a message would prefer to retract a message. In some cases, the message simply may include one or more typographical errors, or perhaps the message may include incorrect information. In other circumstances, a sender of a message may desire to retract a message accidentally designated for delivery to a wrong party. In the latter instance, the consequences of an incorrectly addressed message can be disastrous—particularly in the circumstance where personal content is sent in error to a business associate. However, to the extent that a message is sent in error to an incorrect party utilizing real time messaging, no opportunity for retraction is available.

### BRIEF SUMMARY OF THE INVENTION

Embodiments of the present invention address deficiencies of the art in respect to the retraction of messages in real time messaging and provide a novel and non-obvious method, system and computer program product for verification of message content in a real time messaging system. In an embodiment of the invention, a method for verification of message content in a real time messaging system is provided. The method contextually analyzing a thread of messages in a user interface of a real time messaging system, the thread of messages defining a conversation between a composer of the messages in the thread and one or more recipients of the messages, the contextual analysis determining a context of the conversation. The method further includes loading into memory a new message to be transmitted to the one or more recipients as part of the thread of messages, parsing text of the new message and analyzing the parsed text to determine a context of the new message. The method yet further includes comparing the determined context of the new message to the determined context of the conversation. Finally, the method includes displaying in the user interface a warning to the composer when the context of the new message differs from the context of the conversation.

In another embodiment of the invention, a real time messaging data processing system is configured for verification of message content. The system includes a host computing device that has memory and at least one processor. The system also includes a real time messaging client executing in the host computing device. Finally, the system includes a content verification module coupled to the client. The module includes program code enabled upon execution in the memory of the host computing device to contextually analyze a thread of messages in a user interface of the real time messaging client, the thread of messages defining a conversation between a composer of the messages in the thread and one or more recipients of the messages, the contextual analysis determining a context of the conversation, to load into the memory a new message to be transmitted to the one or more recipients as part of the thread of messages, to parse text of the new message and analyze the parsed text to determine a context of the new message, to compare the determined context of the new message to the determined context of the conversation and to display in the user interface a warning to the composer when the context of the new message differs from the context of the conversation.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for verification of message content in a real time messaging system;

FIG. 2 is a schematic illustration of a real time message data processing system configured for verification of message content; and,

FIG. 3 is a flow chart illustrating a process for verification of message content in a real time messaging system.

### DETAILED DESCRIPTION OF THE INVENTION

Embodiments of the invention provide for verification of message content in a real time messaging system. In accordance with an embodiment of the invention, text can be received in a real time messaging interface for transmission to a designated recipient. A thread of messages transmitted to the recipient can be loaded into memory and analyzed to determine a context of a conversation defined by the thread of messages. The context can include a subject of the conversation, a tone of the conversation, or a relationship between the recipient and a composer of the messages of the conversation. Thereafter, a new message can be composed in the user interface for delivery to the recipient. Text of the new message can be parsed and analyzed, and a context can be determined for the new message. The context of the new message can be compared to the context determined for the thread of messages. To the extent the context of the new message is dissimilar to the context of the thread of messages, a warning in the user interface can be presented to the composer of the message.

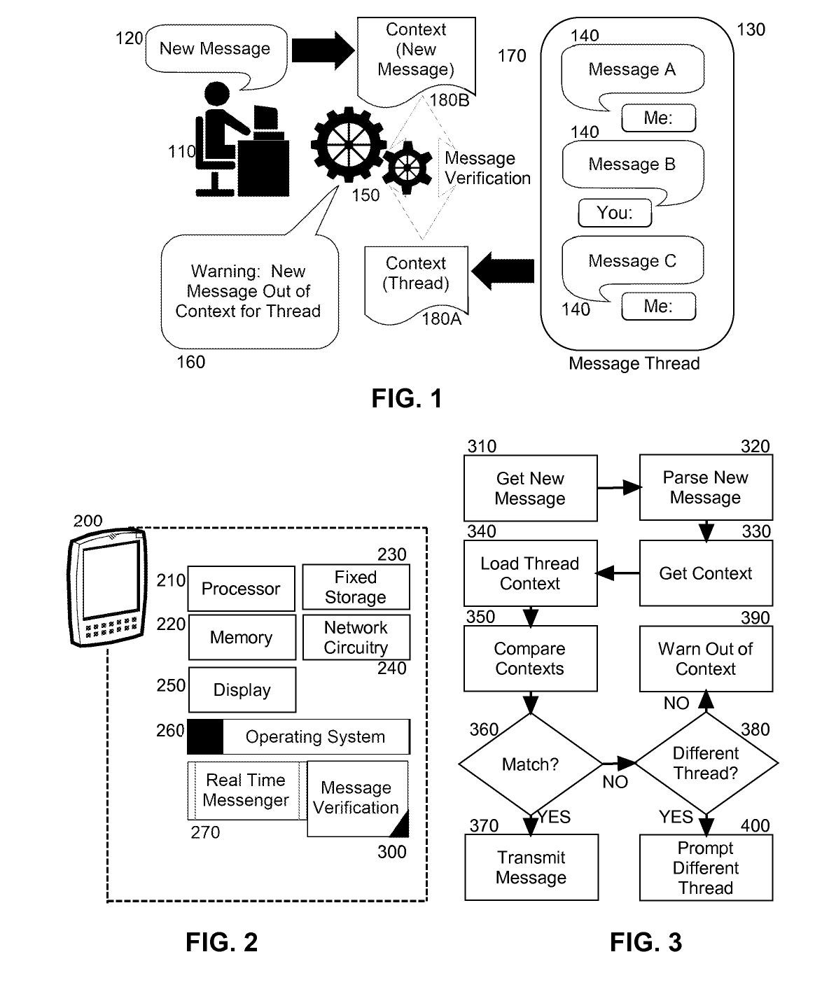

In further illustration, FIG. 1 pictorially shows a process for verification of message content in a real time messaging system. As shown in FIG. 1, a composer 110 can create a new message 120 for inclusion within a message thread 130 of different messages 140 exchange between the composer 110 and one or more recipients. Message verification logic 150 can compare a context 180A of a conversation defined by the message thread 130 with a context 180B determined for the new message 120. To the extent that the contexts 180A, 180B are dissimilar, the message verification logic 150 can display a prompt 160 for the composer 110 indicating that the new message 120 is out of context in respect to the conversation defined by the message thread 130.

The process described in connection with FIG. 1 can be implemented in a real time messaging system. In yet further illustration, FIG. 2 schematically shows a real time message data processing system configured for verification of message content. The system can include a host computing system 200 that includes a processor 210 and memory 220 and fixed storage 230. The host computing system 200 also includes network circuitry 240 and a display 250. The host computing system 200 yet further includes an operating system 260 supporting the operation of one or more applications and moderating access by the applications to the memory 210, memory 220, fixed storage 230, network circuitry 240 and display 250.

Of note, the operating system 260 can host the operation of a real time messenger 270, for example a text messenger or instant messenger. The real time messenger 270 can be configured to transmit and receive real time messages with one or more recipients, organized in accordance as different threads of the messages each of the thread defining a different conversation, each of the threads being displayed in a separate window of the display 250. Importantly, a message verification module 300 is coupled of the real time messenger 270.

The module 300 includes program code enabled upon execution in the memory 220 to determine a context of a new message composed in the real time messenger 270 and also a context for each thread of messages managed in the real time messenger 270. The program code further is enabled upon execution in the memory 220 to display a prompt in the display 250 in response to comparing the contexts and detecting dissimilarity. Optionally, the program code is yet further enabled upon execution in the memory 220 to determine whether the context of the new message, while dissimilar to a context for a message thread with respect to which the new message had been composed, may be similar to a context for a different message thread. If so, the program code is enabled to display a prompt in the display 250 suggesting placement of the new message in association with the messages of the different message thread.

In even yet further illustration of the operation of the message verification module 300, FIG. 3 is a flow chart illustrating a process for verification of message content in a real time messaging system. Beginning in block 310, a new message can be composed in a real time messenger and in block 320, the message can be parsed and analyzed in order to determine a context for the new message in block 330. For instance, the context can be a relationship between the composer of the new message and a designated recipient of the new message, for instance a work place relationship that can be determined from a directory, a personal relationship determinable from an address book of contacts, or a social networking relationship determinable from a list of contexts in a social network. The context also can include a tone of the message, or a subject of the message.

In block 340, a context of a message thread in respect to which the new message had been composed also can be determined. Thereafter, in block 350 the determined contexts can be compared. In decision block 360, it can be determined if the contexts match. If so, the new message can be transmitted. However, if in decision block 360 if the contexts do not match, in decision block 380 it can be determined if the context determined for the new message is similar to a context of a different message thread. If not, in block 390 a prompt can be issued in the user interface for the real time messenger that the new message is not of the same context as the conversation defined by message thread to which the new message is directed to be posted. However, if so, in block 380 a prompt can be issued recommending placement of the new message in a different conversation defined by the different message thread.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for verification of message content in a real time messaging system, the method comprising:
contextually analyzing a thread of messages in a user interface of a real time messaging system, the thread of messages defining a conversation between a composer of the messages in the thread and one or more recipients of the messages, the contextual analysis determining a context of the conversation;
loading into memory a new message to be transmitted to the one or more recipients as part of the thread of messages;
parsing text of the new message and analyzing the parsed text to determine a context of the new message;
comparing the determined context of the new message to the determined context of the conversation; and,
displaying in the user interface a warning to the composer when the context of the new message differs from the context of the conversation.

2. The method of claim 1, wherein the context of the conversation is a subject of the conversation.

3. The method of claim 1, wherein the context of the conversation is a tone of the conversation.

4. The method of claim 1, wherein the context of the conversation is a relationship between the composer and one or more of the recipients.

5. The method of claim 1, further comprising:
identifying a context of a different conversation defined by a different thread of messages;
comparing the context of the different conversation to the context of the new message; and,
displaying a prompt in the user interface suggesting that the new message is sent in connection with the different thread of messages in response to determining that the context of the new message is similar to the context of the different conversation.

6. A real time messaging data processing system configured for verification of message content, the system comprising:
a host computing device comprising memory and at least one processor;
a real time messaging client executing in the host computing device; and,
a content verification module coupled to the client, the module comprising program code enabled upon execution in the memory of the host computing device to contextually analyze a thread of messages in a user interface of the real time messaging client, the thread of messages defining a conversation between a composer of the messages in the thread and one or more recipients of the messages, the contextual analysis determining a context of the conversation, to load into the memory a new message to be transmitted to the one or more recipients as part of the thread of messages, to parse text of the new message and analyze the parsed text to determine a context of the new message, to compare the determined context of the new message to the determined context of the conversation and to display in the user interface a warning to the composer when the context of the new message differs from the context of the conversation.

7. The system of claim 6, wherein the context of the conversation is a subject of the conversation.

8. The system of claim 6, wherein the context of the conversation is a tone of the conversation.

9. The system of claim 6, wherein the context of the conversation is a relationship between the composer and one or more of the recipients.

10. The system of claim 6, wherein the program code is further enabled to identify a context of a different conversation defined by a different thread of messages, to compare the context of the different conversation to the context of the new message, and to display a prompt in the user interface suggesting that the new message is sent in connection with the different thread of messages in response to determining that the context of the new message is similar to the context of the different conversation.

11. A computer program product for verification of message content in a real time messaging system, the computer program product comprising a computer readable storage medium having program instructions embodied therewith, the program instructions executable by a device to cause the device to perform a method comprising:
contextually analyzing a thread of messages in a user interface of a real time messaging system, the thread of messages defining a conversation between a composer of the messages in the thread and one or more recipients of the messages, the contextual analysis determining a context of the conversation;
loading into memory a new message to be transmitted to the one or more recipients as part of the thread of messages;
parsing text of the new message and analyzing the parsed text to determine a context of the new message;
comparing the determined context of the new message to the determined context of the conversation; and,
displaying in the user interface a warning to the composer when the context of the new message differs from the context of the conversation.

12. The computer program product of claim 11, wherein the context of the conversation is a subject of the conversation.

13. The computer program product of claim 11, wherein the context of the conversation is a tone of the conversation.

14. The computer program product of claim 11, wherein the context of the conversation is a relationship between the composer and one or more of the recipients.

15. The computer program product of claim 11, wherein the method further comprises:
identifying a context of a different conversation defined by a different thread of messages;
comparing the context of the different conversation to the context of the new message; and,
displaying a prompt in the user interface suggesting that the new message is sent in connection with the different thread of messages in response to determining that the context of the new message is similar to the context of the different conversation.
